(19) United States
(12) Patent Application Publication
(10) Pub. No.: US 2004/0252265 A1
(43) Pub. Date: Dec. 16, 2004

(54) Liquid crystal display

(76) Inventors: Jung Ho Ma, Kyoungki-do (KR); Seung Ho Hong, Kyoungki-do (KR); Seong Wook Shin, Kyoungki-do (KR); Sang Un Choi, Kyoungki-do (KR)

Correspondence Address: LADAS & PARRY LLP, 224 SOUTH MICHIGAN AVENUE, SUITE 1200, CHICAGO, IL, 60604, US

(21) Appl. No.: 10/834,468

(22) Filed: Apr. 29, 2004

(30) Foreign Application Priority Data
Jun. 12, 2003 (KR) 2003-38019

(51) Int. Cl. G02F 1/1335

(52) U.S. Cl. 349/130

(57) ABSTRACT

Disclosed is a liquid crystal display capable of being adaptable for appliances providing moving pictures and TV-based high-performance devices. The liquid crystal display comprises an upper substrate and a lower substrate disposed in opposition to each other; a liquid crystal layer interposed between the upper and lower substrates; a color resin layer formed on an inside surface of the upper substrate; a counter electrode formed on a surface of the color resin layer including the valleys; a pixel electrode formed on an inside surface of the lower substrate; vertical alignment layers interposed between the pixel electrode and the liquid crystal layer and between the counter electrode and the liquid crystal layer; and polarizing sheets attached on outer surfaces of the upper and lower substrates.

### BACKGROUND OF THE INVENTION

1. Field of the Invention

The present invention relates to a liquid crystal display, and more particularly to a liquid crystal display to be operated at high-speed response so that it is adaptable for appliances providing moving pictures and TV-based high-performance devices.

2. Description of the Prior Art

As generally known in the art, a vertical alignment mode LCD (Liquid Crystal Display) has been proposed to solve problems of a narrow viewing angle and a low response speed characteristic represented in a twisted nematic (TN) mode LCD. Although it is not shown, the vertical alignment mode LCD includes upper and lower substrates, each of which is equipped with a liquid crystal drive electrode. A liquid crystal layer including liquid crystal molecules having a negative dielectric anisotropy is interposed between the upper and lower substrates. Vertical alignment layers are aligned on opposite surfaces of the upper and lower substrates. Also, polarizing sheets, which have polarization axes intersecting with each other, are attached on outer faces of the upper and lower substrates, respectively.

However, the vertical alignment mode LCD has a refractive anisotropy characteristic due to a bar shape of liquid crystal, so that screen images are differently represented depending on the viewing angles. For example, before an electric field is formed, the liquid crystal molecules are vertically aligned on the substrates so that a completely dark screen is represented in front of the screen. However, when viewing the screen from a side thereof, quality of the screen image is deteriorated due to light leakage.

In order to solve such a problem, there have been proposed various vertical alignment mode LCDs capable of improving a_viewing angle by aligning liquid crystal molecules in two or four directions through distorting an electric field.

For example, what has been called a multi-domain vertical alignment mode LCD using protrusions as means for distorting an electric field has been proposed through U.S. Pat. No. 6,288,762, filed by Fujitsu Ltd. of Japan, and its construction is shown in FIG. 1.

Referring to FIG. 1, a lower substrate 11 and an upper substrate 12 are disposed in opposition to each other while interposing liquid crystal molecules 13 therebetween. Protrusions 14 are formed on opposite surfaces of the lower substrate 11 and the upper substrate 12, respectively.

According to such a structure, when an electric field is formed, the electric field is distorted in vicinity of each protrusion 14, so that the liquid crystal molecules 13 are aligned symmetrically to each other. Therefore, multiple domains of a liquid crystal are formed, thereby compensating for degradation of image quality resulting from the dielectric anisotropy of the liquid crystal molecules.

Also, as a means for distorting an electric field, what has been called a patterned vertical alignment mode LCD, which uses slits as means for distorting an electric field, has been proposed by Samsung Electronics Co., Ltd. of Korea, and its construction is shown in FIG. 2.

Referring to FIG. 2, liquid crystal drive electrodes 23 and 24 of upper and lower substrates 21 and 22 have a slit structure, respectively. The driving principle of the patterned vertical alignment LCD is identical to that of the multi-domain vertical alignment LCD having protrusion structures shown in FIG. 1.

Meanwhile, in FIG. 2, each slit serves as a source for driving, or in other words, tilting, the liquid crystal molecules. Herein, as shown in FIGS. 3A and 3B, it can be understood that as the interval between slits 36 is shorter, that is, as the slits 36 are formed in relatively greater numbers, response time becomes shorter and shorter. Such a phenomenon is identically shown as well in the case of the multi-domain vertical alignment LCD having protrusion structures of FIG. 1.

In FIGS. 3A and 3B, reference numerals 31 and 32 represent a lower substrate and an upper substrate, respectively. In addition, reference numerals 33 and 34 represent liquid crystal drive electrodes, and reference numeral 35 represents liquid crystal molecules, respectively.

However, when the number of tilting sources increases so as to decrease response time, that is, when the number of the protrusions or the slits increases, the number of disclination lines increases, thereby not only decreasing transmittance but also adversely causing property degradation, such as an increase of response time or an increase of a driving voltage.

Therefore, various new structures have been proposed in order to improve the structural problems existing in the above-mentioned protrusion and slit structures. Of these, there is one particular so-called advanced super view (hereinafter, referred to as “ASV”) mode LCD proposed by Sharp Co., Ltd. of Japan, in which an electric field is distorted in a circle shape so as to align liquid crystal molecules in a pinwheel shape.

FIG. 4 is a view for explaining a conventional ASV mode LCD.

With this structure, tilting sources are protrusions, and the protrusions are formed in a pinwheel structure. Therefore, liquid crystal molecules are aligned in a pinwheel shape along the protrusions formed in the pinwheel structure.

However, although it is not shown and described in detail, the conventional ASV mode LCD having protrusions formed in a pinwheel structure has a problem in that disclination lines, which must be generated at each center portion of the protrusions, are asymmetrically generated at positions deviated from the center portions of the protrusions because too many chiral dopant are mixed with liquid crystal molecules. Particularly, since an asymmetrical structure of the pinwheel shape causes uneven brightness in a low gradation, it is necessary to restrict such a phenomenon in order to obtain a uniform image quality.

Additionally, when fabricating the conventional ASV mode LCD, an additional masking process is required to form the protrusions having a pinwheel pattern, thereby increasing the number of fabricating steps and fabricating cost.

### SUMMARY OF THE INVENTION

Accordingly, the present invention has been made to solve the above-mentioned problems occurring in the prior art, and an object of the present invention is to provide a liquid crystal display capable of obtaining uniform image quality.

Another object of the present invention is to provide a liquid crystal display which can be fabricated through a simple process at a low cost.

Still another object of the present invention is to provide a liquid crystal display which can be operated at high-speed response so that it is adaptable for appliances providing moving pictures and TV-based high-performance devices.

In order to accomplish these objects, there is provided a liquid crystal display comprising: an upper substrate and a lower substrate disposed in opposition to each other spaced by a predetermined interval; a liquid crystal layer interposed between the upper and lower substrates, and including liquid crystal molecules of negative dielectric anisotropy; a color resin layer formed on an inside surface of the upper substrate, and including a predetermined number of valleys regularly formed at an inner portion of each unit pixel; a counter electrode formed on a surface of the color resin layer including the valleys; a pixel electrode formed on an inside surface of the lower substrate, and including slits having a ‘+’ shape disposed around each valley of the upper substrate; vertical alignment layers interposed between the pixel electrode and the liquid crystal layer and between the counter electrode and the liquid crystal layer, respectively; and polarizing sheets attached on outer surfaces of the upper and lower substrates, respectively, in such a manner that polarization axes of the polarizing sheets intersect with each other.

Herein, each valley has a depth of 2 μm or less, each sectional area of a valley has a rectangular shape in which a length of a short lateral side is 5 μm or less, and each wall surface of a valley must be inclined at an angle of 10 to 90°. Two to ten valleys are formed at an inner portion of each unit pixel.

Dielectric anisotropy of the liquid crystal molecules is in a range of about −2 to −10, a thickness of the liquid crystal layer is in a range of about 2 to 6 μm, and a value obtained by multiplying the dielectric anisotropy of liquid crystal molecule by the thickness of the liquid crystal layer is in a range of about 200 to 500 nm.

Also, the liquid crystal display of the present invention further comprises an opaque pattern installed on a slit formation portion of the pixel electrode.

In addition, the liquid crystal display of the present invention further comprises phase compensation plates, each of the phase compensation plates being installed between the upper substrate and a first polarizing sheet and between the lower substrate and a second polarizing sheet. The phase compensation plate is one-axis or two-axis phase compensation plate, in which the one-axis phase compensation plate includes phase retardation values of a range of about 40 to 800 nm, and two-axis phase compensation plate includes phase retardation values of a range of about 150 to 250 nm.

According to the present invention, tilting sources, which permit the liquid crystal molecules to be laid in a pinwheel shape, are provided in a form of a valley, thereby forming a pinwheel structure capable of representing a uniform viewing angle. Also, such tilting sources having the shape of the valley can be simultaneously formed when patterning a color resin layer in the fabrication course of the upper plate, so that it is possible to simplify a fabricating process for the liquid crystal display.

### BRIEF DESCRIPTION OF THE DRAWINGS

The above and other objects, features and advantages of the present invention will be more apparent from the following detailed description taken in conjunction with the accompanying drawings, in which:

FIGS. 1 and 2 are views illustrating conventional liquid crystal displays using protrusions and slits, respectively;

FIGS. 3A and 3B are views for explaining variation of response time and transmittance according to the number of sources tilting liquid crystal molecules in each unit length;

FIG. 4 is a photographic view for explaining a problem of a conventional liquid crystal display using a pinwheel structure;

FIGS. 5A and 5B are a plan view and a sectional view of an upper substrate of a liquid crystal display according to the present invention, respectively;

FIG. 6 is a view for explaining a driving status of the liquid crystal display according to the present invention;

FIG. 7 is a view for explaining the driving principle of the liquid crystal display according to the present invention; and

FIG. 8 is a photographic view showing pixels of the liquid crystal display according to the present invention.

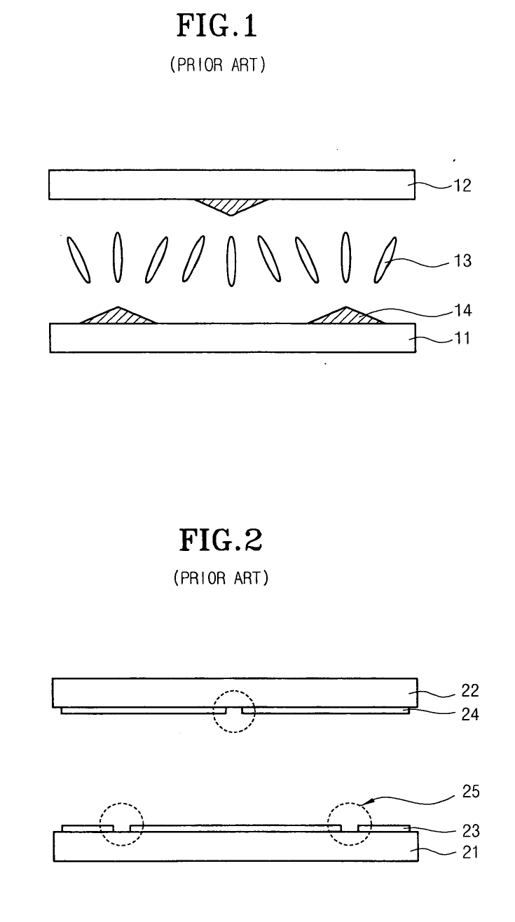

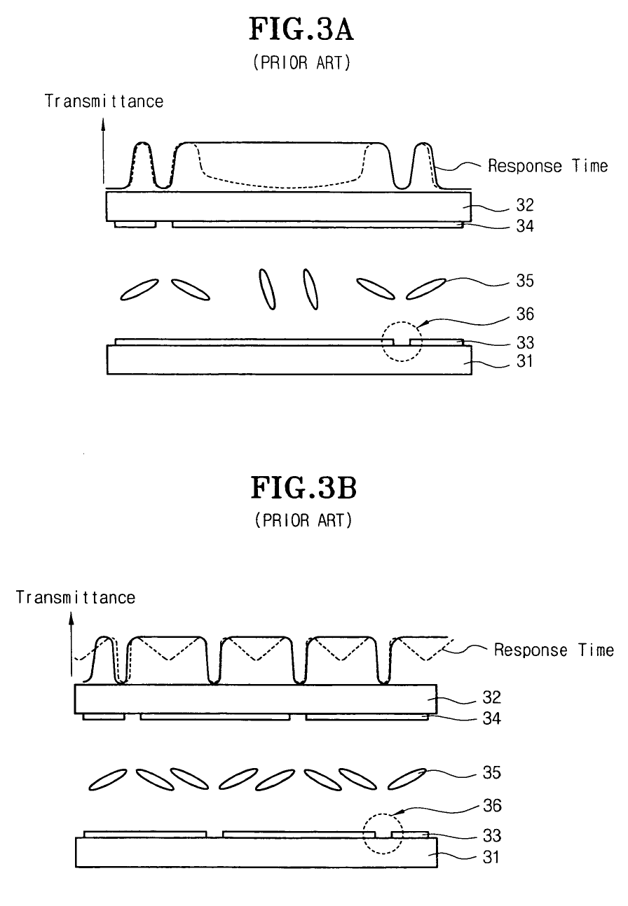

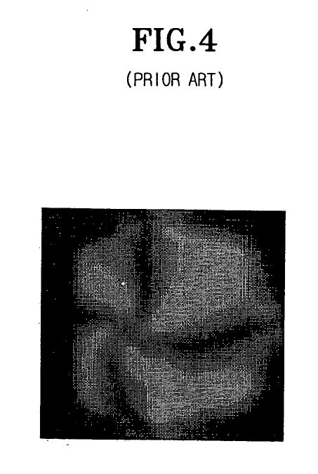

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

Although it is not shown, a liquid crystal display according to an embodiment of the present invention includes a lower substrate and an upper substrate which have liquid crystal drive electrodes, that is, a pixel electrode and a counter electrode, respectively. The lower and upper substrates are attached in opposition to each other with a liquid crystal layer interposed, in which the liquid crystal layer includes a plurality of liquid crystal molecules with a negative dielectric anisotropy. Vertical alignment layers are interposed between the lower substrate and the liquid crystal layer and between the upper substrate and the liquid crystal layer, respectively. On outer faces of the upper and lower substrates, polarizing sheets are attached in such a manner that polarization axes of the polarizing sheets intersect with each other.

Also, in the liquid crystal display according to the present invention, an RGB (red, green and blue) color resin layer for obtaining color is interposed between the upper substrate and the counter electrode. In the color resin layer, a predetermined number of valleys, for example, two to forty valleys, are regularly formed at positions corresponding to pixels.

Such valleys are formed together with the resin layer for the RGB colors while a patterning process of forming the RGB color resin layer is being performed, so that an additional masking process for forming the valleys is not needed. Herein, the color resin layer must have a thickness of 2 μm of less such that each valley has a depth of 2 μm or less, each sectional area of a valley must have a rectangular shape in which a length of a short lateral side is 5 μm or less, and each wall surface of a valley must be inclined at an angle of about 10 to 90°.

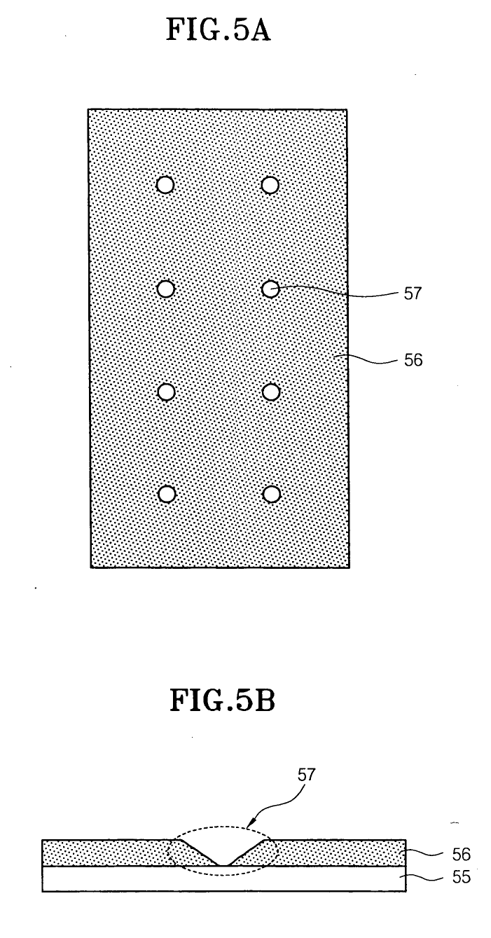

FIGS. 5A and 5B are a plan view and a sectional view of the upper substrate in a liquid crystal display according to the present invention, respectively. Herein, reference numerals 55, 56, and 57 represent the upper substrate, the color resin layer, and the valley, respectively.

In addition, in the liquid crystal display according to the present invention, slits are formed in the pixel electrode so as to be aligned around each valley of the upper substrate. For example, such a slit may be formed in a ‘+’ shape.

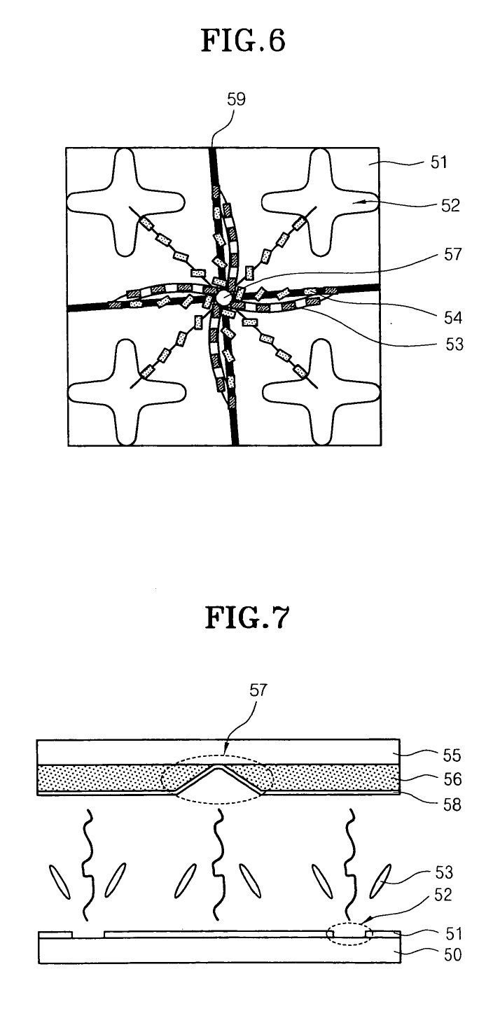

FIG. 6 is a view for explaining a driving status of the liquid crystal display according to the present invention. Referring to FIG. 6, it can be shown that liquid crystal molecules 53 and 54 are aligned in a pinwheel structure about a valley 57. Herein, a tilting source causing the liquid crystal molecules 53 and 54 to be laid in a form of a pinwheel is the valley 57, and a pinwheel structure capable of providing a uniform viewing angle can be formed through the formation of the valley 57. The slits 52 of the pixel electrode 51 are aligned around the valley 57. In FIG. 6, reference numeral 59 represents a polarizer transmission axis.

Meanwhile, in the liquid crystal display according to the present invention, as shown in FIG. 7, the liquid crystal is driven in such a manner that when an electric field is applied to the valleys 57 tilting sources, the liquid crystal molecules are laid while being aligned in a pinwheel shape because the valley 57 is entirely covered with a transparent electrode, that is, with a counter electrode 58. Accordingly, disclination lines are formed within the region of the valley 57, and transmission of light is restricted, so that it is possible to prevent transmittance degradation caused by a thin color filter of the upper substrate.

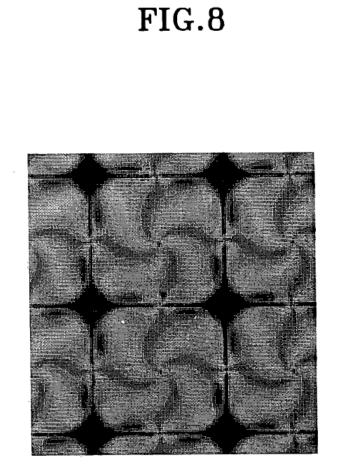

Also, each slit 52 of the ‘+’ shape, which is in the pixel electrode 51 formed on the lower substrate 50, serves as a titling source similar to the valley 57, but functions to buffer disclination lines formed between different valleys. FIG. 8 is a photographic view showing a liquid crystal display fabricated using this construction. Referring to FIG. 8, it is understood that disclination lines are not formed in a portion deviated from a center portion of a pinwheel, but formed only in the slit portions having ‘+’ shapes.

Consequently, the liquid crystal display of the present invention uses the valley as a tilting source for aligning the liquid crystal molecules in a form of a pinwheel while using an intact pinwheel structure, thereby obtaining a more uniform viewing angle characteristic, and in particular, simplifying a fabricating process because an additional masking process for forming the valleys is not needed.

In addition, the liquid crystal display of the present invention includes a great number of the valleys, that is, a great number of tilting sources, thereby providing a rapid response time and improving a viewing angle, so that it is possible to achieve a complete infinite domain formation.

Meanwhile, in the above-mentioned liquid crystal display according to the present invention, liquid crystal molecules having a negative dielectric anisotropy must be used, and also a chiral dopant has to be added to the liquid crystal molecules. Herein, the addition of the chiral dopant is performed for the purpose of preventing such disproportion as the liquid crystal molecules are aligned at a state turned to the light or to the left when they are aligned in a pinwheel shape. At this time, it is preferred for liquid crystal molecules to have a pitch of 100 μm or less.

Also, in the liquid crystal display of the present invention, phase compensation plates may be additionally included between a polarizing sheet and the lower substrate and between the upper substrate and a polarizing sheet, respectively. Herein, phase retardation values (Rth) with respect to x, y and z directions of the phase compensation plates are calculated from the following equation 1.

Equation 1

Rth=[(nx+ny)/2−nz]×d

For example, when one-axis phase compensation plates are used, preferred phase retardation values (Rth) are in a range of about 40 to 800 nm, and when two-axis phase compensation plates are used, preferred phase retardation values (Rth) are in a range of about 150 to 250 nm.

In addition, in the liquid crystal display of the present invention, it is preferred that the dielectric anisotropy of liquid crystal molecule is in a range of about −2 to −10, it is preferred that a thickness of the liquid crystal layer is in a range about 2 to 6 μm, and it is preferred that a value (d*Δn) found by multiplying the dielectric anisotropy of liquid crystal molecule by the thickness of the liquid crystal layer is in a range about 200 to 500 nm.

In addition, in the liquid crystal display of the present invention, an opaque pattern may be installed in the slit formation portions of the pixel electrode. Through this construction, the disclination lines may be hidden by the opaque pattern, thereby improving image quality.

As described above, the present invention forms tilting sources, which permit the liquid crystal molecules to be laid in a pinwheel shape, in a form of a valley, thereby providing a uniform viewing angle. Also, the present invention permits disclination lines to be formed at center portions of the valleys, thereby decreasing loss of transmittance. Particularly, the present invention can provide a high-speed response by forming a plurality of valleys, so that it is possible to obtain liquid crystal displays capable of being adaptable for appliances providing moving pictures and TV-based high-performance devices.

In addition, according to the present invention, the valleys are simultaneously formed when patterning the color resin layer in the fabrication course of the upper plate without using any separate masking process, so that it is possible to simplify a fabricating process for the liquid crystal display.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A liquid crystal display comprising:
an upper substrate and a lower substrate disposed in opposition to each other spaced by a predetermined interval;
a liquid crystal layer interposed between the upper and lower substrates, and including liquid crystal molecules of negative dielectric anisotropy;
a color resin layer formed on an inside surface of the upper substrate, and including a predetermined number of valleys regularly formed at an inner portion of each unit pixel;
a counter electrode formed on a surface of the color resin layer including the valleys;
a pixel electrode formed on an inside surface of the lower substrate, and including slits having a ‘+’ shape disposed around each valley of the upper substrate;
vertical alignment layers interposed between the pixel electrode and the liquid crystal layer and between the counter electrode and the liquid crystal layer, respectively; and
polarizing sheets attached on outer surfaces of the upper and lower substrates, respectively, in such a manner that polarization axes of the polarizing sheets intersect with each other.

2. The liquid crystal display as claimed in claim 1, wherein, each valley has a depth of 2 μm or less, each sectional area of a valley has a rectangular shape in which a length of a short lateral side is 5 μm or less, and each wall surface of a valley must be inclined at an angle of 10 to 90°.

3. The liquid crystal display as claimed in claim 1, wherein, two to forty valleys are formed at an inner portion of each unit pixel.

4. The liquid crystal display as claimed in claim 1, further comprising an opaque pattern installed on a slit formation portion of the pixel electrode.

5. The liquid crystal display as claimed in claim 1, further comprising phase compensation plates, each of the phase compensation plates being installed between the upper substrate and a first polarizing sheet and between the lower substrate and a second polarizing sheet.

6. The liquid crystal display as claimed in claim 5, wherein the phase compensation plate is one-axis or two-axis phase compensation plate, in which the one-axis phase compensation plate includes phase retardation values of a range of about 40 to 800 nm, and two-axis phase compensation plate includes phase retardation values of a range of about 150 to 250 nm.

7. The liquid crystal display as claimed in claim 1, wherein dielectric anisotropy of the liquid crystal molecules is in a range of about −2 to −10.

8. The liquid crystal display as claimed in claim 1, wherein a thickness of the liquid crystal layer is in a range of about 2 to 6 μm, and a value obtained by multiplying the dielectric anisotropy of liquid crystal molecule by the thickness of the liquid crystal layer is in a range of about 200 to 500 nm.
